(19) United States
(12) Patent Application Publication
(10) Pub. No.: US 2024/0413454 A1
(43) Pub. Date: Dec. 12, 2024

(54) BATTERY DEVICE

(71) Applicant: TOYOTA JIDOSHA KABUSHIKI KAISHA, Toyota-shi (JP)

(72) Inventors: Takenori MIKAMI, Miyoshi-shi (JP); Kenji BABA, Toyota-shi (JP); Haruhiko MURASE, Toyota-shi (JP)

(73) Assignee: TOYOTA JIDOSHA KABUSHIKI KAISHA, Toyota-shi (JP)

(21) Appl. No.: 18/599,645

(22) Filed: Mar. 8, 2024

(30) Foreign Application Priority Data
Jun. 7, 2023 (JP) 2023-094361

(51) Int. Cl. H01M 50/24; H01M 50/204; H01M 50/251; H01M 50/691

(52) U.S. Cl. CPC H01M 50/24; H01M 50/204; H01M 50/251; H01M 50/691; H01M 2220/10

(57) ABSTRACT

The battery device includes a plurality of battery pack assemblies vertically stacked and accommodated in a support member. Each of the plurality of battery pack assemblies includes a battery pack and a tray. The tray is positioned below the battery pack and includes a frame and a bottom plate connected to the frame. The frame includes an upper face that supports the battery pack, and a lower face that is supported by the support member. The bottom plate is disposed upward from the lower face of the frame.

### CROSS-REFERENCE TO RELATED APPLICATION

This application claims priority to Japanese Patent Application No. 2023-094361 filed on Jun. 7, 2023, incorporated herein by reference in its entirety.

### BACKGROUND

### 1. Technical Field

The present disclosure relates to a battery device.

### 2. Description of Related Art

WO 2016/129385 discloses a power storage device. The power storage device includes a plurality of battery packs and a storage battery board. The battery packs are housed on the storage battery board. The battery packs are disposed stacked in an up-down direction (vertical direction) on the storage battery board.

### SUMMARY

In the power storage device described in WO 2016/129385, when the center of gravity of the power storage device becomes high due to the stacking of the battery packs, stability of the power storage device may decrease.

The present disclosure has been made in view of the above-described problems, and it is an object thereof to provide a battery device that enables improved stability by suppressing rising of the center of gravity due to the stacking of battery packs.

A battery device according to the present disclosure includes a plurality of battery pack assemblies accommodated stacked in an up-down direction on a support member.

Each of the battery pack assemblies includes
a battery pack, and
a tray.
The tray is positioned below the battery pack and includes a frame and a bottom plate connected to the frame.
The frame includes an upper face that supports the battery pack, and a lower face that is supported by the support member.
The bottom plate is disposed upward from the lower face of the frame.

According to the battery device of the present disclosure, the tray for supporting the battery pack includes the bottom plate disposed upward from the lower face of the frame. Accordingly, distance between the battery pack assemblies adjacent to each other in the up-down direction can be shortened while securing a gap that is necessary between the two. As a result, rising of the center of gravity of the battery device due to the stacking of the battery packs can be suppressed, and thus stability of the battery device can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a main part of a battery device according to an embodiment;

FIG. 2 is a perspective view of the battery pack assembly shown in FIG. 1;

FIG. 3 is a diagram for describing a raised bottom structure of the tray according to the embodiment;

FIG. 4 is a diagram for explaining a configuration of a tray according to a modification of the embodiment; and

FIG. 5 is a view for explaining a raised-bottom configuration of the tray shown in FIG. 4.

### DETAILED DESCRIPTION OF EMBODIMENTS

Embodiments of the present disclosure will be described with reference to the accompanying drawings. In the drawings, the same reference numerals are assigned to the same elements, and redundant descriptions are omitted or simplified.

### 1. Configuration of Battery Device

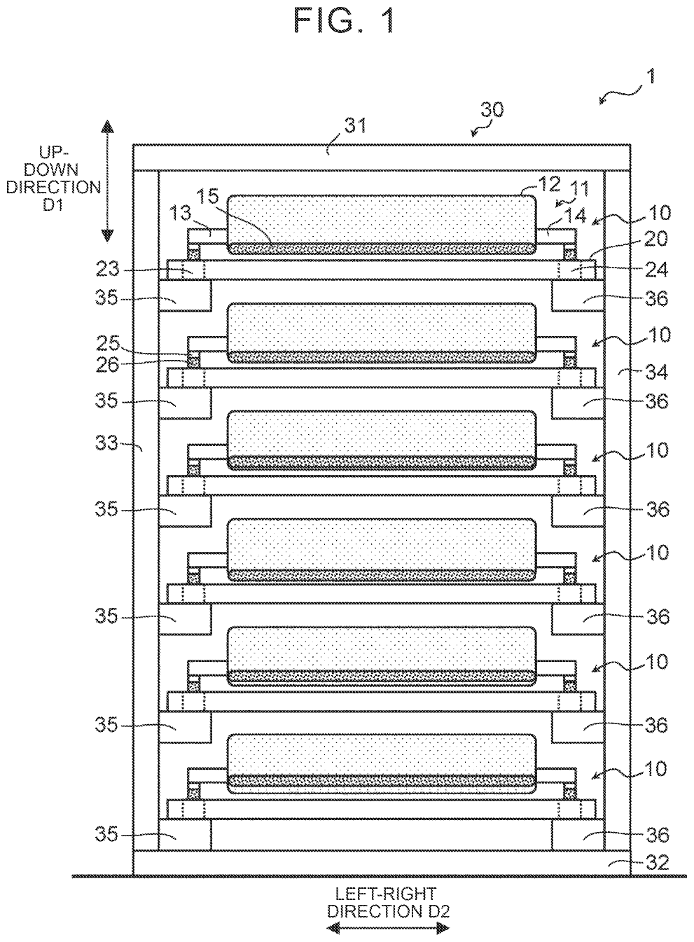

FIG. 1 is a diagram schematically illustrating an exemplary configuration of a main of the battery device 1 according to the embodiment. The battery device 1 is installed in a stationary place. The battery device 1 is also referred to as a stationary power supply. The battery device 1 is configured to store electric power supplied from the outside and supply electric power to a predetermined electric power supply target. The battery device 1 can be used, for example, as a backup power supply (emergency power supply) in a power failure (including an emergency in a natural disaster or the like).

The battery device 1 includes a battery pack assembly (or simply a battery assembly) 10 and a support member 30. The battery assembly 10 is an assembly of the battery pack 11 and the tray 20. The number of battery assemblies 10 mounted on the battery device 1 may be one, but is basically a plurality. In the exemplary embodiment shown in FIG. 1, six battery assemblies 10 are stacked and accommodated in the support member 30 in the up-down direction D1 (vertical direction) of the battery device 1.

In the present embodiment, the battery pack 11 is an in-vehicle battery pack. That is, the in-vehicle battery pack is diverted as the battery pack 11 of the battery device 1. Thus, cost reduction of the battery device 1 and effective utilization of resources can be achieved. More specifically, the in-vehicle battery pack may be a used product after being used on a vehicle, or may be a new product.

The respective battery assemblies 10 are moved into and out of the support member 30 from a predetermined direction (from the inserting direction D3 shown in FIG. 4). FIG. 1 is a view of the support member 30 in which the battery assembly 10 is accommodated from the direction of the inlet/outlet 2 (refer to FIG. 4).

The support member 30 has, for example, a rectangular parallelepiped skeleton structure. In FIG. 1, the frame members 31 to 34 located on the sides of the inlet/outlet 2 among the plurality of frame members included in the support member 30 are illustrated. The frame members 31 and 32 extend in the left-right direction D2 (horizontal direction) at the upper end and the lower end of the support member 30, respectively. The frame members 33 and 34 extend in the up-down direction D1 at respective ends of the support member 30 in the left-right direction D2.

The support member 30 further includes a pair of rails 35 and 36 for each battery assembly 10 that support the battery assembly 10. The pair of rails 35 and 36 extend along the depth of the page in FIG. 1. The pair of rails 35 and 36, together with the frame members 33 and 34, for example, are fixed to the other frame members 37 and 38, the reinforcing member 39, and 40 (refer to FIG. 4). The rails 35 and 36 correspond to an example of a “support member” according to the present disclosure.

In addition, the battery device 1 includes a battery assembly 10 and a support member 30, as well as “other components” that are not shown. Other components include, for example, power converter units (including boost converters) 50 (see FIG. 4), electronic control units (ECU), and electric equipment such as high voltage relays. Other components also include, for example, wire harnesses (including high voltage cables and connectors) and cooling device components (e.g., coolant piping, pumps, radiators, radiator fans, and reservoir tanks). As an example, in the battery device 1, the components used on the vehicle together with the in-vehicle battery pack are also diverted to these “other components”. As a result, cost reduction and effective utilization of resources can be more effectively achieved.

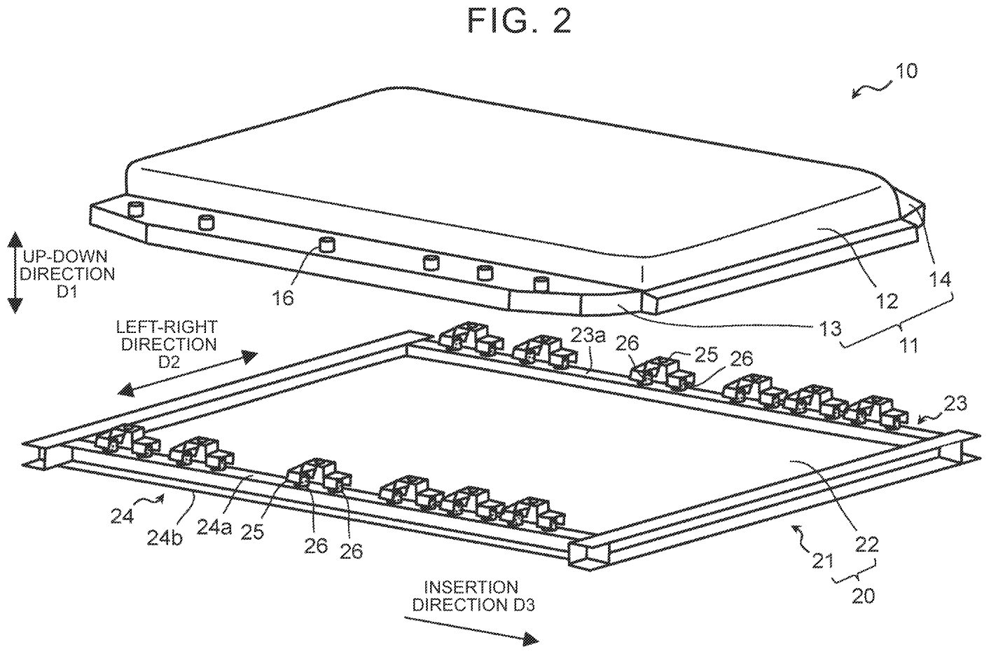

Next, a specific configuration of the battery assembly 10 will be described referring to FIG. 1 and to FIG. 2. FIG. 2 is a perspective view of the battery assembly 10 shown in FIG. 1.

The battery pack 11 includes a pack main body 12 and a pair of fixing portions 13 and 14. The pack main body 12 houses a plurality of secondary battery cells (not shown) and a cooler 15. The cooler 15 constitutes a part of the above-described cooling device. The cooler 15 exchanges the coolant flowing therein with the plurality of secondary battery cells in the pack main body 12. As a result, the plurality of secondary battery cells is cooled.

The tray 20 is located below the battery pack 11. The tray 20 includes a frame 21 and a bottom plate 22. The frame 21 is formed in a rectangular frame shape, for example. The bottom plate 22 is connected to the frame 21. The frame 21 has a pair of frame portions 23 and 24 located on both sides in the left-right direction D2. Each of the pair of frame portions 23 and 24 has an upper face 23a and a 24a that support the battery pack 11. The pair of frame portions 23 and 24 have a lower face 23b and a 24b supported by the rails 35 and 36, respectively.

More specifically, a plurality of brackets 25 for fixing the battery pack 11 to the tray 20 are attached to each of the upper face 23a and 24a. The pair of fixing portions 13 and 14 of the battery pack 11 are fixed to the pair of frame portions 23 and 24 via the plurality of brackets 25, respectively. This fixing can be performed, for example, by fastening using a fastener such as a bolt 16.

In addition, each of the plurality of brackets 25 may be directly attached to the frame portion 23 or 24. On the other hand, as shown in FIG. 2, each of the plurality of brackets 25 may be attached to the frame portion 23 or 24 via the insulator 26. The use of the insulator 26 is supplemented as follows. As described above, the battery pack 11 is an in-vehicle battery pack. The battery pack used in the battery device 1 can be required to have a higher withstand voltage than the in-vehicle battery pack. Therefore, by interposing the insulator 26 between the battery pack 11 and the tray 20, when the in-vehicle battery pack that does not satisfy the withstand voltage required by the battery device 1 is diverted to the battery pack 11, the insulation property of the battery pack 11 can be appropriately secured without the need to increase the withstand voltage of the battery pack 11 itself.

### 2. Raised Bottom Structure

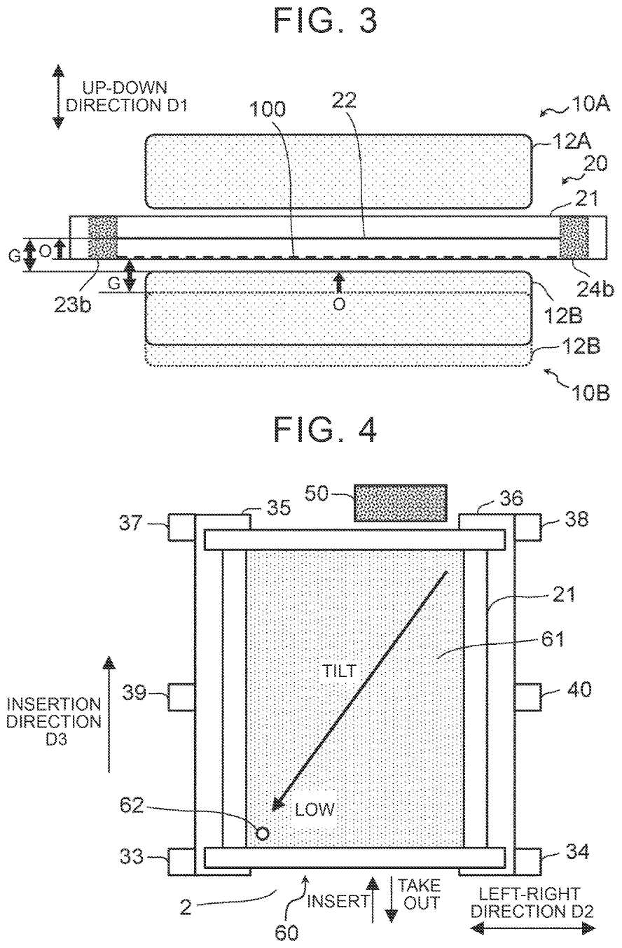

FIG. 3 is a diagram for explaining a configuration of the tray 20 according to the embodiment. FIG. 3 shows the battery assembly 10A, which is one of the plurality of battery assemblies 10, including the pack main body 12A and the tray 20, and the pack main body 12B of the battery assembly 10B at the lower part of one stage of the battery assembly 10A.

In FIG. 3, the bottom plate 100 (comparative example) is shown together with the bottom plate 22 for comparison. The bottom plate 100 is located at the same height as the lower face 23b and 24b of the frame 21. That is, the bottom plate 100 is not provided in a raised bottom shape with respect to the lower face 23b and 24b.

The gap G in FIG. 3 corresponds to the minimum required gap between the bottom plate of the upper battery assembly 10A and the lower pack main body 12B from the viewpoint of the performance of the battery device 1. Therefore, in the embodiment of the bottom plate 100, the pack main body 12B cannot be brought closer to the battery assembly 10A than the position represented by the broken line due to the restriction of the gap G.

On the other hand, the bottom plate 22 according to the present embodiment is disposed above the lower face 23b and 24b of the frame 21 by the offset O. Accordingly, the pack main body 12B can be brought close to the battery assembly 10A to a position indicated by a solid line while securing the gap G. That is, the distance between the battery assembly 10A and the battery assembly 10B in the up-down direction D1 can be shortened by the offset O. According to such a raised bottom structure, it is possible to suppress an increase in the center of gravity of the battery device 1 caused by the stacking of the battery packs 11, and thus the stability (earthquake resistance) of the battery device 1 is improved.

### 3. Modification

FIG. 4 is a diagram for describing a configuration of a tray 60 according to a modification of the embodiment. FIG. 4 is a top view of the tray 60 supported by a pair of rails 35 and 36. The tray 60 according to this modification is different from the tray 20 shown in FIG. 2 in that a bottom plate 61 is provided instead of the bottom plate 22.

As shown in FIG. 4, the bottom plate 61 of the tray 60 has a drain hole 62. The drain hole 62 is formed so as to penetrate the bottom plate 22. The bottom plate 61 is inclined so as to be lower toward the drain hole 62 as shown in FIG. 4.

According to the bottom plate 61 configured as described above, the following effects can be obtained. That is, water may adhere to the surface of the battery pack 11 due to, for example, condensation. Further, the coolant leaked from the coolant pipe or the cooler 15 may adhere to the surface of the battery pack 11. According to the bottom plate 61, for example, water adhering to the surface of the battery pack 11 in this way can be prevented from falling onto the lower battery pack 11 (in this respect, the same applies to the bottom plate 22 described above). In addition, a drain hole 62 is formed in the bottom plate 61. Accordingly, it is possible to prevent water from overflowing from the tray 60. More specifically, by selecting the position of the drain hole 62, water can be discharged from a desired position such as a position not overlapping with the battery pack 11 in a top view. This leads to suppression of occurrence of a short circuit in the battery pack 11 or an electric device connected thereto, that is, to improvement in safety of the battery device 1. The bottom plate 61 is inclined so as to be lowered toward the drain hole 62. Thus, the drainage performance of the tray 60 can be improved.

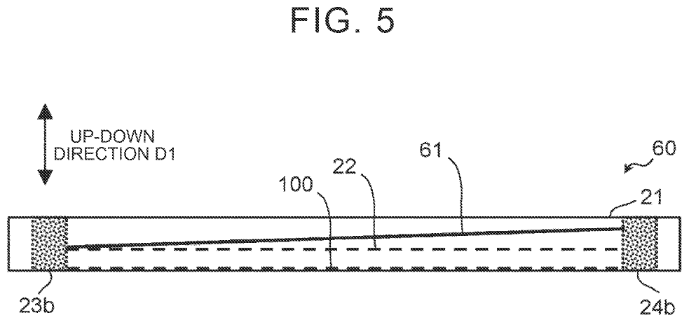

FIG. 5 is a diagram for explaining a raised-bottom configuration of the tray 60 shown in FIG. 4. The lines of the bottom plate 61 represented in of FIG. 5 are obtained at the end of the bottom plate 61 close to the inlet/outlet 2. Bottom plates 22 and 100 are also shown in FIG. 5, along with the bottom plate 61 for comparison.

As can be seen from FIG. 5, the bottom plate 61 has a raised bottom structure, similarly to the bottom plate 22. More specifically, the bottom plate 61 has the same height as the bottom plate 22 even at the lowest position. Therefore, as in the case where the bottom plate 22 is used, the center of gravity of the battery device 1 can also be lowered by the bottom plate 61. As described above, according to the use of the bottom plate 61, by appropriately setting the magnitude of the offset O, it is possible to improve the stability (earthquake resistance) of the battery device 1 while improving the drainage performance of the tray 60.

In addition, broadly speaking, the position of the drain hole 62 on the bottom plate 61 is not particularly limited, and may be, for example, the center of the bottom plate 61. In addition, in the present embodiment, the drain holes 62 are formed at the corners (more specifically, one of the four corners) of the bottom plate 61 as shown in FIG. 4. Accordingly, the position of the drain hole 62 can be determined so that the water falling from the drain hole 62 is less likely to be applied to the battery pack 11 in the lower stage. In addition, when the drain hole 62 is formed in the corner of the bottom plate 61, the drain hole 62 may be formed in any one of the three corners other than the corner shown in FIG. 4. Alternatively, the drain holes 62 may be formed in each of two or more corners. The bottom plate 61 may be inclined so as to be lowered toward each of a plurality of corners where the drain hole 62 is formed.

Further, in the modification shown in FIG. 4, the position of the drain hole 62 on the bottom plate 61 is determined by considering the following viewpoints. As shown in FIG. 3, the drain hole 62 is formed at an end of the bottom plate 22 located closer to the inlet/outlet 2 of the battery assembly 10. More specifically, the drain hole 62 is formed in one of the corners on the side of the end. Note that, when the drain hole 62 is formed at the end of the bottom plate 61 located closer to the inlet/outlet 2, the drain hole 62 may be formed at a portion other than the corner at the end, unlike the embodiment shown in FIG. 4. When the drain hole 62 is formed at a portion other than the corner at the end, the bottom plate 61 may be inclined so as to be lower from the end on the side far from the inlet/outlet 2 toward the end on the side close to the inlet/outlet 2.

It can be said that the end on the side close to the inlet/outlet 2 is a portion where the components of the battery device 1, such as the above-described electrical equipment, are not arranged close to each other so as not to prevent the battery assembly 10 from being taken in and out of the support member 30. By forming the drain hole 62 in such a portion, water can be drained from the tray 60 while avoiding water from being applied to the component.

More specifically, in the modified example shown in FIG. 4, the above-described power conversion unit 50, which is an example of an electric device connected to the battery pack 11, is disposed at the same height as the battery pack 11 to be connected and at the back of the inserting-direction D3 as shown in FIG. 4. In relation to the power conversion unit 50, it can be said that the drain hole 62 is formed at an end (for example, a corner of the end) of the bottom plate 61, which is located on the other side of the arrangement location of the power conversion unit 50, in a top view of the bottom plate 61 (that is, in FIG. 4). By forming the drain hole 62 at the end on the side away from the electric appliance (the power conversion unit 50) in this way, it is possible to drain the power conversion unit 50 from the tray 60 while easily avoiding drainage. In addition, the wire harness connecting the power conversion unit 50 and the battery pack 11 can be easily prevented from being drained.

In addition, the drain hole 62 is circular as an example, but is not limited to a circular shape, and may have any shape such as an elongated hole shape (including a slit shape). The number of the drain holes 62 may be two or more.

What is claimed is:

1. A battery device comprising: a plurality of battery pack assemblies accommodated stacked in an up-down direction on a support member, wherein:
each of the battery pack assemblies includes
a battery pack, and
a tray that is positioned below the battery pack and that includes a frame and a bottom plate connected to the frame;
the frame includes an upper face that supports the battery pack, and a lower face that is supported by the support member; and
the bottom plate is disposed upward from the lower face of the frame.

2. The battery device according to claim 1, wherein the bottom plate includes a drain hole and is inclined so as to be lower toward the drain hole.

3. The battery device according to claim 1, wherein the battery pack is supported by the frame via an insulator.

4. The battery device according to claim 1, wherein:
the battery device is installed at a stationary location; and
an in-vehicle battery pack is diverted for use as the battery pack.
